(19) United States
(12) Patent Application Publication
(10) Pub. No.: US 2021/0117886 A1
(43) Pub. Date: Apr. 22, 2021

(54) Data Preparation Method Related to Data Utilization and Data Utilization System

(71) Applicant: Hitachi, Ltd., Chiyoda-ku,Tokyo (JP)

(72) Inventors: Hidenori YAMAMOTO, Tokyo (JP); Kenji KAWASAKI, Tokyo (JP); Takeshi HANDA, Tokyo (JP); Takashi TSUNO, Tokyo (JP)

(21) Appl. No.: 17/046,759

(22) PCT Filed: Feb. 20, 2019
(86) PCT No.: PCT/JP2019/006352

§ 371 Date: Oct. 9, 2020

(30) Foreign Application Priority Data
Apr. 16, 2018 (JP) 2018-078244

(51) Int. Cl. G06Q 10/06; G06F 16/25

(52) U.S. Cl. CPC G06Q 10/0637; G06F 16/25

(57) ABSTRACT

To make a proposal of appropriate data preparation contents for a utilization purpose to a user making utilization of data, and to cause a system providing functions related to data accumulation, data preparation, and data utilization to have high importance level data preparation contents to be prepared for various purposes of various users, in such a manner as to enable facilitating the data utilization for various purposes using diverse data from a plurality of business systems, the system collates a utilization purpose designated by a user with data information prepared by the system, and calculates and presents data preparation content items to be carried out for the utilization purpose and a difficulty level of each item. The system aggregates the data preparation content items for the utilization purpose, categorizes similar data preparation contents, and calculates and presents an importance level of a category. The system creates a list containing processing programs, data definitions, and the like corresponding to the data preparation content items for the data preparation content category, and calculates and presents a usefulness of each item.

### TECHNICAL FIELD

The present invention relates to a data preparation method related to data utilization and a data utilization system.

More specifically, the present invention relates to a data preparation method related to data utilization and a utilization system for preparing and managing data utilized in various purposes and use applications intended at, for example, data from a plurality of business systems.

### BACKGROUND ART

As a data analysis system, a technology described in JP-2010-277534-A (Patent Document 1) is proposed. A “data analysis system for performing data analysis for purposes of discovery of beneficial knowledge for an analyst, and collecting and preprocessing data necessary for the data analysis, the data analysis system including: a data collection side device having a data collection device that collects the data and preprocesses the data, and a data transmitting section that transmits the data preprocessed by the data collection device; and a data analysis side device having a data receiving section that receives the preprocessed data transmitted from the data transmitting section, and a data analysis device that performs the data analysis on the preprocessed data received by the data receiving section” is described in Patent Document 1.

Furthermore, as a data processing system, a technology described in JP-2016-181150-A (Patent Document 2) is proposed. A “data processing system processing input data to generate data for analysis, including: a storage section configured to store a database; a processing section configured to process data stored in the database; and a setting section configured to set a condition required to generate the data for analysis, in which the database includes a data warehouse configured to store all of input data that is input, an integration layer configured to store integrated data after the processing section integrates the input data to generate the integrated data, an aggregation layer configured to store a plurality of pieces of aggregated data after the processing section aggregates the integrated data by at least the number of addition items or the number of non-addition items for each of one or more combinations of the non-addition items to generate the plurality of pieces of aggregated data, and an analysis layer configured to store an analysis data after the processing section selects one aggregated data from the plurality of pieces of aggregated data on the basis of the condition set by the setting section and further extracts the analysis data from the one aggregated data” is described in Patent Document 2.

### PRIOR ART DOCUMENT

### Patent Documents

Patent Document 1: JP-2010-277534-A
Patent Document 2: JP-2016-181150-A

### SUMMARY OF THE INVENTION

### Problems to be Solved by the Invention

In the case of accumulating and managing data collected from a plurality of business systems and providing analyzed data to an application utilizing the analyzed data, it is required to collect a large volume of business data across departments or businesses and to carry out analysis of the business data in order to solve various problems with businesses in fields, which are, for example, transportation, electric power, industrial, and other fields. However, need to understand a large volume of business data, heavy dependence on personal skills based on business knowledge, and the like serve to hamper carrying out of analysis under present circumstances.

It is, therefore, required to enable even a person insufficient in knowledge of analysis and processing of business data and in business knowledge to carry out analysis promptly and easily and to reduce load related to creation and carrying out of analysis processing on various kinds of business data.

The invention disclosed by Patent Document 1 is to create a program correspondence table between analysis processing corresponding to an analysis purpose and preprocessing in advance, refer to the program correspondence table, distribute a preprocessing program corresponding to the analysis purpose to the data collection device, and carry out preprocessing conforming to the purpose on individual raw data. With the technology, it is necessary to pinpoint all of the analysis purposes and the intended raw data in advance and create the correspondence table between the analysis processing and the preprocessing; thus, a specific type of data is utilized only for the purposes within the scope of the assumption. In other words, setting diverse data from a plurality of systems as object data causes an increase in load on the creation of the correspondence table between the preprocessing and the analysis.

Moreover, the invention disclosed by Patent Document 2 is intended to generate integrated data by integrating all input data, generate aggregated data by each of various items, extract necessary data from the integrated data and the aggregated data, and create analysis data depending on a purpose; thus, with the technology, data that can be utilized is limited to data for which the integrated data can be created. It is not always possible to uniformly create integrated data for diverse data from a plurality of business systems. It is also necessary to understand all of original data for creating the analysis data appropriate for the purpose from the integrated data and the aggregated data. In other words, the technology disclosed by Patent Document 2 has a problem that it is not always possible to uniformly create integrated data for diverse data from a plurality of systems.

As described above, while data utilization systems providing functions and the like related to data accumulation, data preparation, and data utilization of data from business systems has been conventionally introduced to promote data utilization for purposes of solution of business-related challenges, inquiries into business-related abnormal causes, and the like, only functions that can be made effective use of only within the limited scope assumed in advance or standard functions that can be used for general-purpose are provided as in the technology disclosed by either Patent Document 1 or Patent Document 2 described above to meet user's diverse purposes of utilization. Owing to this, problems including a possible increase in user's own burden in work related to data preparation and data utilization for achieving the diverse purposes of utilization remain.

An object of the present invention is, therefore, to provide a technology capable of facilitating data utilization for diverse purposes of utilization of data from a plurality of business systems in a system that provides functions related to data accumulation, data preparation, and data utilization in light of the problems described above.

An object is, for example, to provide, as to solution of business-related challenges, inquiries into business-related abnormal causes, and the like, a technology capable of handling data analysis, formulation of solution of problems of the data analysis, creation of a business application for solution of problems, and the like, and capable of facilitating proposing appropriate high importance level data preparation contents (data preparation content items) to a user making data utilization for various purposes using diverse data.

Specifically, an object of the present invention is to provide a data preparation method related to data utilization and a data utilization system proposing, for example, appropriate data preparation contents (work items of tabulation, data coupling/data extraction, data structuring, and data processing: data preparation content items) to a user (analyst or developer) making utilization of data, and presenting data preparation contents (high importance level data preparation contents to be prepared) for various purposes of various users to a user (administrator) managing the present system.

### Means for Solving the Problems

To solve the problems, one of the representative data preparation methods related to data utilization and representative data utilization systems according to the present invention includes: a function to collate a utilization purpose designated by a user making utilization of data with information containing data preparation content items prepared by the system having a data preparation function and a data utilization function, to calculate data preparation content items to be carried out for the utilization purpose and a difficulty level, and to present the calculated data preparation content items and the calculated difficulty level to the user making utilization of the data; a function to aggregate data preparation content items for the utilization purpose, to categorize similar data preparation contents, to calculate a importance level of a category of the similar data preparation content items, and to present the calculated importance level of the category to a user managing the system; and a function to create a list containing processing programs and data relation definitions corresponding to the data preparation content items for the categories of the data preparation contents, to calculate usefulnesses of the data preparation content items, and presenting the calculated usefulnesses to the user making utilization of the data.

### Advantages of the Invention

According to the present invention, it is possible to achieve reduction in cost required to carry out data utilization including analysis using diverse data from a plurality of business systems. Particularly, in the case of constructing a data utilization system intended at a plurality of users, it is possible to contribute to providing more useful functions and services related to data preparation for data utilization.

Objects other than the object described above, configurations, and advantages will be readily apparent from the description of embodiments given below.

### BRIEF DESCRIPTION OF THE DRAWINGS

FIG. 1 is a block diagram depicting a configuration of a system to which a data preparation method related to data utilization according to the present invention is applied.

FIGS. 2A and 2B are diagrams depicting a use case in the case of carrying out the data preparation method related to data utilization according to the present invention.

FIG. 3 is an explanatory diagram of prerequisites of data preparation related to data utilization according to the present invention.

FIG. 4 is a diagram depicting a module configuration of a data utilization infrastructure server according to the present invention.

FIG. 5A is a diagram depicting an example of configurations of utilization purposes created by a user and data information prepared by the data utilization infrastructure server in the data preparation method related to data utilization according to the present invention, and a diagram depicting an example of utilization purposes.

FIG. 5B is a diagram depicting an example of a data catalog.

FIG. 5C is a diagram depicting an example of a processing program list.

FIG. 5D is a diagram depicting an example of data relation information.

FIG. 6A is a diagram depicting a configuration of a table managed by the data utilization infrastructure server according to the present invention and used to carry out the data preparation method related to data utilization, and a diagram depicting a data configuration of a data preparation content proposal management table.

FIG. 6B is a diagram depicting a data configuration of a data preparation content category management table.

FIG. 6C is a diagram depicting a data configuration of a useful data preparation content item management table.

FIGS. 7A to 7D are flowcharts depicting a flow of processing for collating a user's created utilization purpose with data information prepared by a data utilization system and calculating data preparation contents to be carried out and difficulty levels by the data utilization system in the case of applying the data preparation method related to data utilization according to the present invention.

FIGS. 8A and 8B are flowcharts depicting a flow of processing for determining similarities of the data preparation contents per item from data preparation proposal achievements and categorizing similar data preparation contents by the data utilization system in the case of applying the data preparation method related to data utilization according to the present invention.

FIG. 9 is a flowchart depicting a flow of processing for calculating an importance level of the category of the data preparation contents according to the present invention.

FIG. 10 is a flowchart depicting a flow of processing for creating a list containing processing programs corresponding to the data preparation content items, data definitions, and the like as a result of registration of the data preparation content items by the user according to the present invention.

FIGS. 11A to 11C are diagrams depicting conceptual screenshots of screens provided to users using user terminals to which the present invention is applied.

### MODES FOR CARRYING OUT THE INVENTION

Embodiments of the present invention will be described hereinafter with reference to the drawings.

### First Embodiment

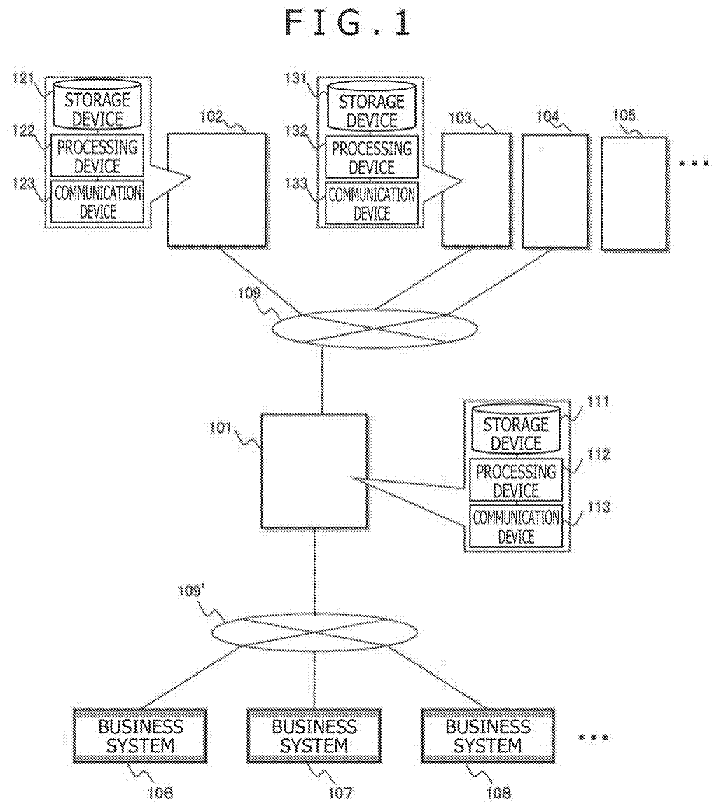

FIG. 1 is a block diagram depicting a configuration of a system to which a data preparation method related to data utilization according to the present invention is applied.

A system to which a data preparation method related to data utilization is applied is configured with a data utilization infrastructure server 101, an administrator terminal 102, a plurality of user terminals 103 to 105, and a plurality of business systems 106 to 108 that construct a data utilization system. While a case in which the number of user terminals and the number of business systems are three in the present embodiment, each number is not limited to a specific one.

The data utilization infrastructure server 101 is connected to the administrator terminal 102 and the plurality of user terminals 103 and 104 via a network 109 and mutually connected with the plurality of business systems 106 to 108 via a network 109′.

While business data (raw data) to be utilized is collected by the business systems 106 to 108 and supplied to the data utilization infrastructure server 101 via the network 109′ in the present embodiment, the business data (raw data) may be manually and directly input to the data utilization infrastructure server 101 without via the network 109′.

It is assumed that a user is an analyst, a developer, a system administrator, or the like poor in knowledge of on-site data and high in IT literacy.

The analyst is a person making discovery of a problem, formulation of a solution, and the like using various analysis approaches and analysis tools with respect to various data across departments.

The developer is a person developing an analysis application necessary for analysis work. The system administrator is a person managing and operating a data utilization system and registering and managing processing logic programs for accumulation, processing, and the like of raw data from business systems.

Furthermore, the data utilization infrastructure server 101 has functions to accumulate data that is the business data (raw data) and that is to be utilized, to execute preparation processing on the data for utilization, and to make proposals associated with data preparation contents, a similar category, importance levels, usefulnesses, and the like to the users (analyst and developer) making management of data relation information, processing programs, and the like for data relation definitions related to data preparation and utilization and carrying out data utilization, and to the user (system administrator) managing the data utilization infrastructure server 101 in the data utilization system (present system).

To execute preparation processing on the data for utilization means to collate a utilization purpose including, for example, at least requested data items and an input data structure with data information including a data catalog and data relation information and prepared by the present system, to perform gap evaluation thereof, to select object data (data/file/system) from the raw data, to calculate data preparation content items (work items) of data preparation (object data, tabulation, data coupling/extraction, data structuring, and data processing) for the object data to be carried out and difficulty levels thereof, and to propose (output) the data preparation.

The difficulty level means herein a magnitude of load required for work conducted by a user. In the case of a low difficulty level, it is expected that work load is light by reuse of the processing program or the like.

In other words, the data utilization infrastructure server 101 has a function to collate the utilization purpose designated by the user making utilization of data with the data information including the data preparation content items and prepared by the present system, a function to calculate the data preparation content items to be carried out for the utilization purpose and the difficulty levels thereof, and to present the calculated data preparation content items and the calculated difficulty levels to the user making utilization of the data, a function to aggregate the data preparation content items for the utilization purpose, and to categorize similar data preparation contents, a function to calculate a importance level of a category of the similar data preparation content items, and to present the calculated importance level of the category to a user managing the system, and a function to create a list containing processing programs corresponding to the data preparation content items and data definitions for categories of the data preparation contents, to calculate usefulnesses of the data preparation content items, and to present the calculated usefulnesses to the user making utilization of data.

To aggregate the data preparation content items, to categorize similar data preparation contents, to calculate importance levels of categories, and to present the calculated importance levels mean, for example, to aggregate data preparation proposal achievements and/or a carrying-out result and to present the importance levels of the data preparation contents (items for which processing logic programs are to be preferentially prepared) to the user.

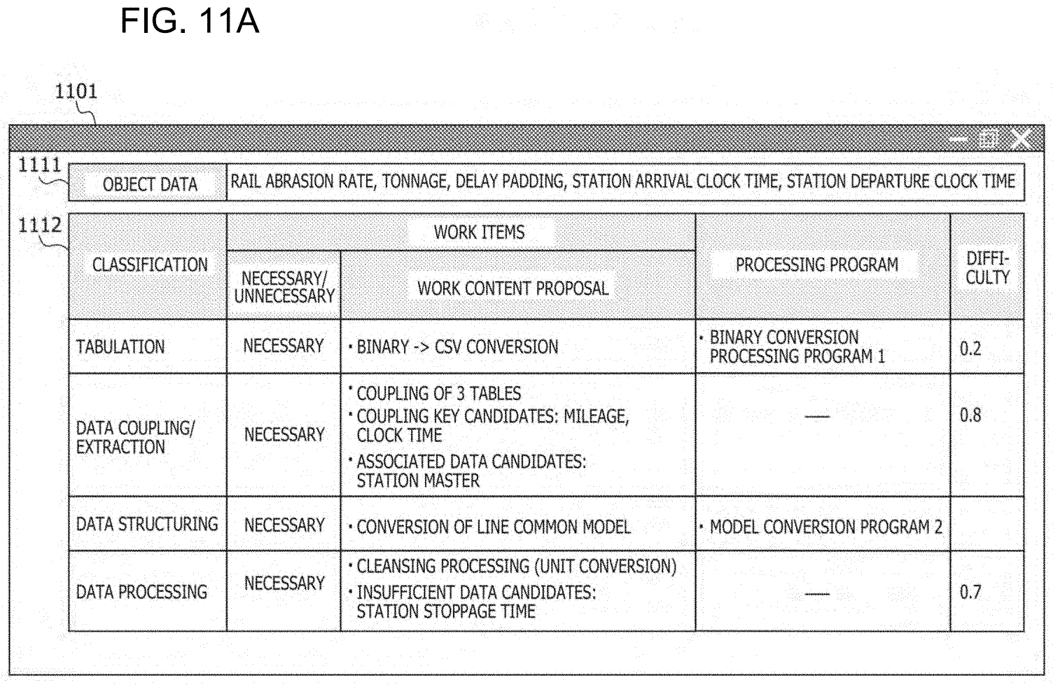

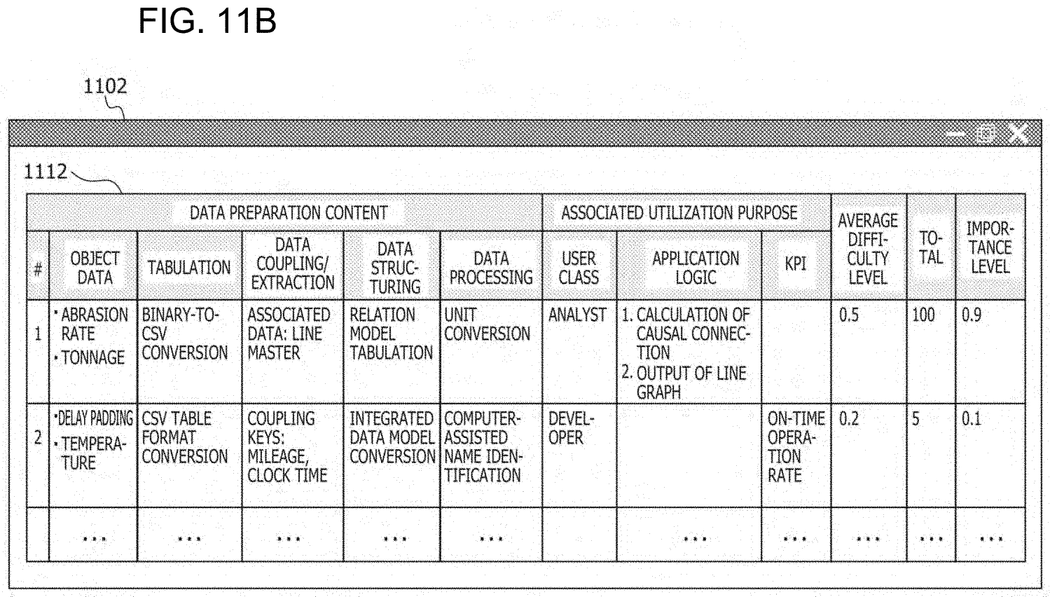

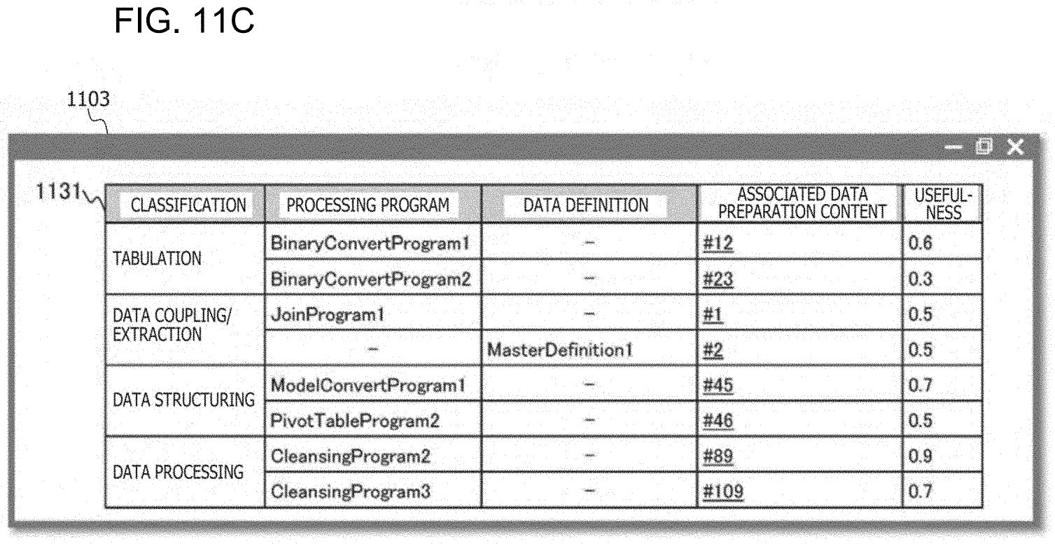

More specifically, to aggregate the data preparation content items, to categorize similar data preparation contents, to calculate importance levels of categories, and to present the calculated importance levels mean (1) to calculate the difficulty levels of the data preparation contents at the time of proposing the data preparation contents for the utilization purpose described above to the user, (2) to record a calculation result of the difficulty levels as data preparation proposal achievements, to determine similarities of the items of the data preparation contents from the data preparation proposal achievements, to categorize similar data preparation contents, to list associated utilization purposes, and (3) to calculate an average difficulty level of each group of the data preparation contents or a total number thereof, and calculate importance levels (degrees of need in utilization) on the basis of the calculated average difficulty levels or the total number, and to create a table (refer to FIGS. 11(A) to 11(C)) containing the data preparation contents, the utilization purposes (candidates), the average difficulty levels, the total numbers, the importance levels, and the like. The table is updated whenever a proposal to the utilization purpose is carried out.

The administrator terminal 102 is a terminal used for the user who is an administrator managing the data utilization system and the data utilization infrastructure server 101 in the data utilization system.

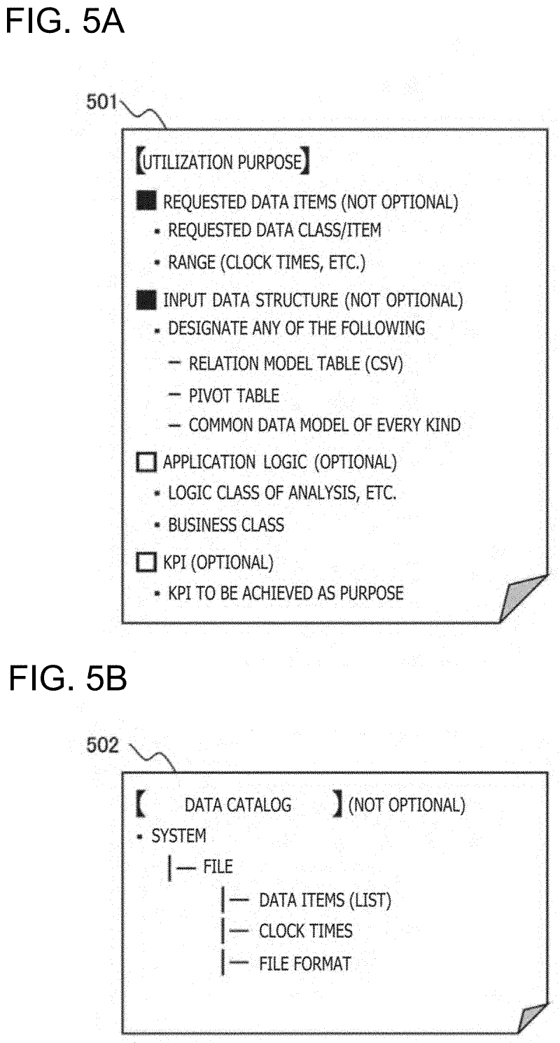

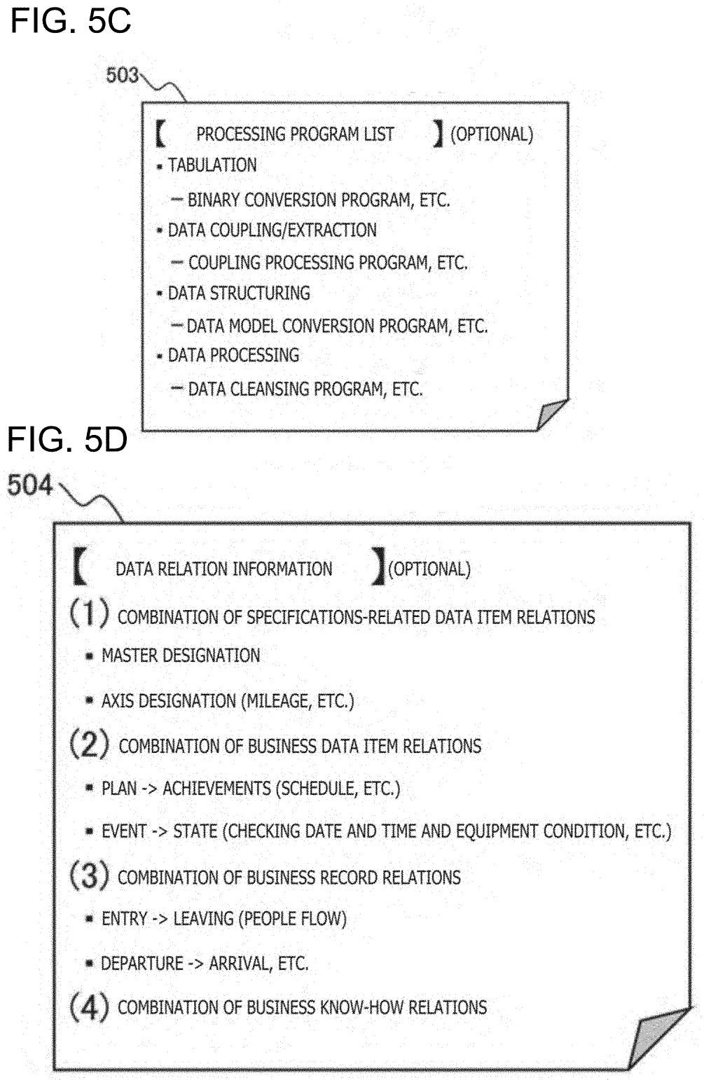

The user terminals 103 to 105 are terminals used by the users such as the analyst and the developer (users making utilization of data) carrying out work related to registration of information indicating the utilization purpose by the users (refer to 501 in FIG. 5(A)), confirmation of the data preparation contents, and data preparation.

The business systems 106 to 108 are business systems that are sources of data to be utilized and that are to be subjected to solution of problems by analysis.

A main hardware configuration of the data utilization infrastructure server 101 includes a storage device (memory and hard disk) 111, a processing device (CPU) 112, and a communication device 113.

Similarly to the data utilization infrastructure server 101, a main hardware configuration of each of the administrator terminal 102 and the user terminals 103 to 105 includes a storage device (memory and hard disk) 121 or 131, a processing device (CPU) 122 or 132, and a communication device 123 or 133.

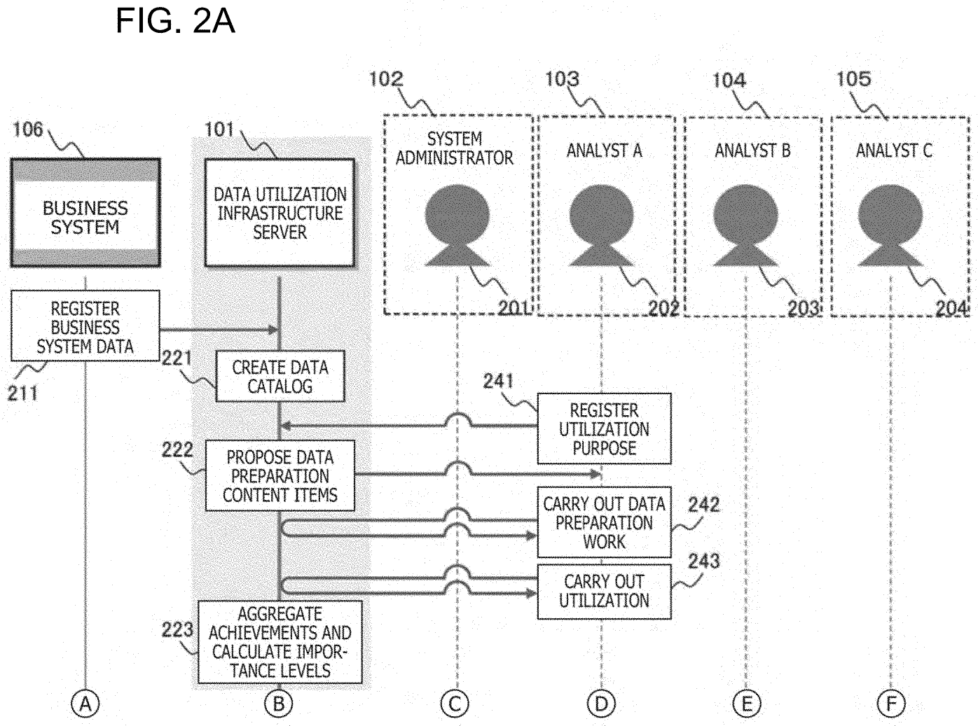

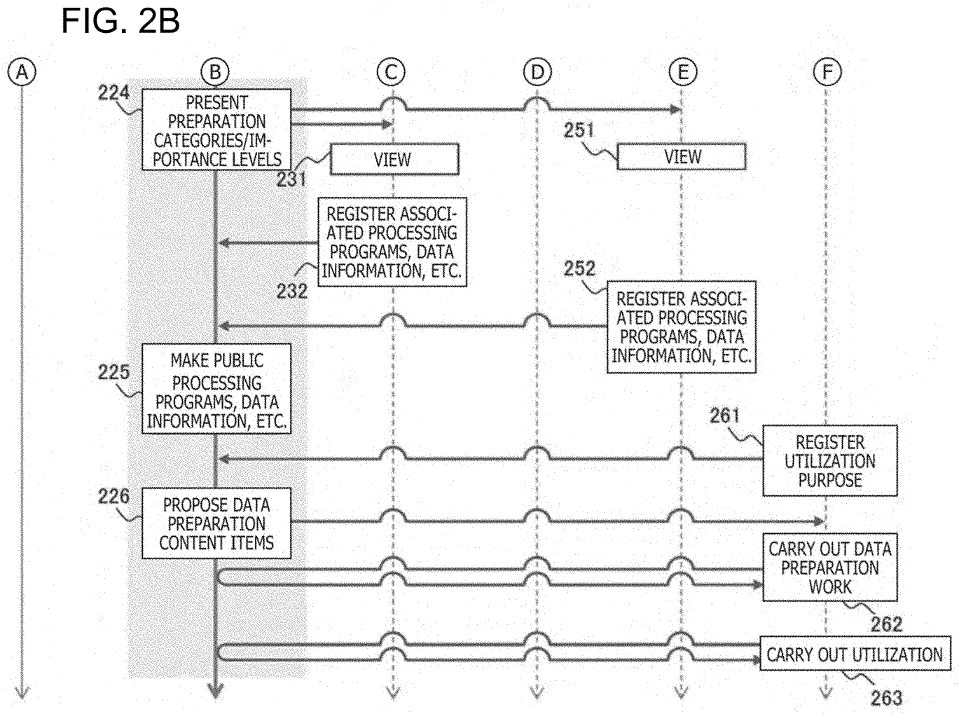

FIGS. 2(A) and 2(B) are diagrams depicting a use case in the case of carrying out the data preparation method related to data utilization according to the present invention, and are explanatory diagrams of processing procedures among the data utilization infrastructure server 101, the business system 106, a system administrator 201 of the administrator terminal 102, and analysts 202 to 204 of the user terminals 103 to 105.

Description will be given hereinafter with respect to FIGS. 2(A) and 2(B) while referring the analysts 202 to 204 as “analysts A to C.”

Operations based on a sequence of FIGS. 2(A) and 2(B) are as follows.

The business system 106 registers business data in the storage device 111 of the data utilization infrastructure server 101 (Step 211).

The data utilization infrastructure server 101 creates, on receipt of the business data from the business system 106, a data catalog associated with the business data of the business system 106 in the processing device 112 (Step 221).

The data catalog is used to describe therein a system, that is, a system configured with files each containing data items (list), is specifically as depicted in, for example, FIG. 5(B), and will be described later.

The analyst A registers a utilization purpose in the storage device 111 of the data utilization infrastructure server 101 in the present system using the user terminal 103 with respect to data utilization such as analysis to be carried out (Step 241).

The utilization purpose contains requested data items and an input data structure, is specifically as depicted in, for example, FIG. 5(A), and will be described later.

The data utilization infrastructure server 101 executes data preparation processing by the processing device 112, and proposes a result of the data preparation processing to the analyst A via the communication device 113. In other words, the data utilization infrastructure server 101 proposes data preparation content items of data preparation contents for the utilization purpose registered by the analyst A to the analyst A (Step 222).

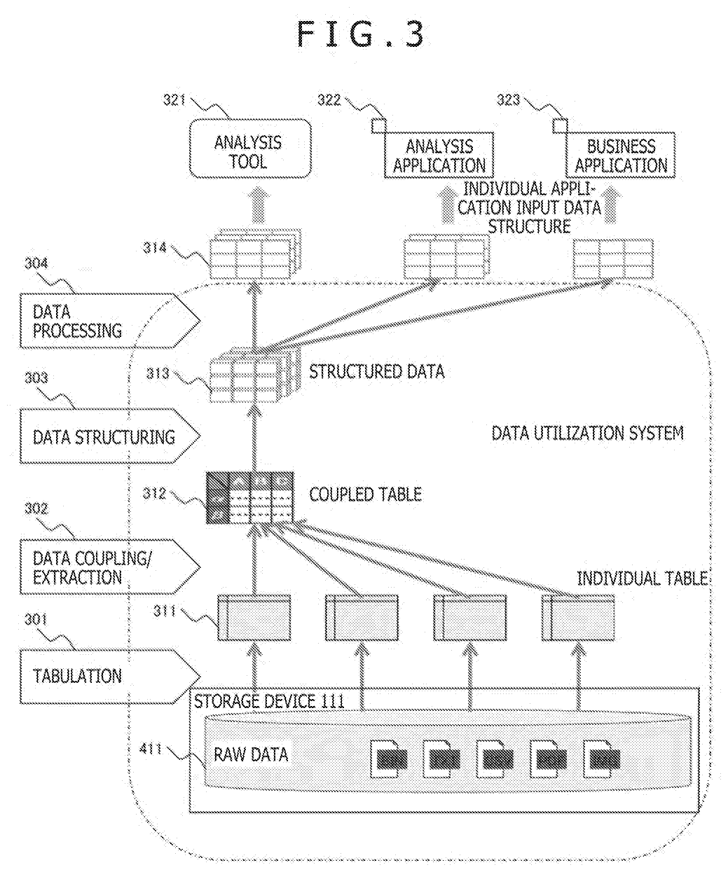

The analyst A refers to the data preparation content items proposed by the data utilization infrastructure server 101, and carries out data preparation work as preprocessing for carrying out data utilization processing conforming to the utilization purpose (Step 242). The data preparation work as the preprocessing will be described later with reference to FIG. 3.

Furthermore, the analyst A carries out the data preparation work (Step 242) and carries out data utilization processing while making utilization of a result of the data preparation work (Step 243).

The analyst A can carry out herein the data preparation work (Step 242) and the utilization (Step 243) while making utilization of the functions and the like provided to the data utilization infrastructure server 101.

In the data utilization infrastructure server 101, the processing device 112 aggregates achievements of the proposal of the data preparation content items for the utilization purpose (Step 222), and carries out categorization of the data preparation content items and calculation of importance levels (Step 223).

Next, the data utilization infrastructure server 101 presents categories and importance levels of the data preparation content items to the system administrator 201 and another analyst B via the communication device 113 (Step 224).

The system administrator 201 and the analyst B can thereby view the categories and the importance levels of the data preparation contents from the data utilization infrastructure server 101 using the administrator terminal 102 and the user terminal 104 (Steps 231 and 251).

At this time, the system administrator 201 and the analyst B register associated processing programs, associated data relation information, and the like corresponding to the categories of the data preparation content items, if present, in the storage device 111 of the data utilization infrastructure server 101 in the present system (Steps 232 and 252). The processing programs and the data relation information will be described later with reference to FIGS. 5(C) and 5(D).

This registration is intended to expand functions and services for data utilization provided by the data utilization infrastructure server 101.

Next, upon accepting the registration of the processing programs, the data relation information, and the like from the system administrator 201 and the analyst B, the data utilization infrastructure server 101 makes public the processing programs, the data relation information, and the like such that another user (analyst C) can also utilize the programs and the like (Step 225).

Similarly to the analyst A, the analyst C registers a utilization purpose in the storage device 111 of the data utilization infrastructure server 101 with respect to data utilization such as analysis to be carried out using the user terminal 105 (Step 261).

Furthermore, the data utilization infrastructure server 101 proposes data preparation content items for the utilization purpose to the analyst C via the communication device 113 (Step 226).

At this time, the data utilization infrastructure server 101 can carry out proposal with higher accuracy by using the processing programs, the data relation information, and the like registered in the system.

The analyst C carries out data preparation work as preprocessing for carrying out data utilization processing conforming to the utilization purpose while referring to the data preparation content item proposal after being reflective of the registration of the associated processing programs, the associated data relation information (data relation definitions), and the like proposed by the data utilization infrastructure server 101 in Step 226 (Step 262).

Furthermore, the analyst C carries out data utilization processing (Step 263) while making utilization of a result of carrying out the data preparation work (Step 262).

FIG. 3 is an explanatory diagram of prerequisites of data preparation related to data utilization according to the present invention.

The business data (raw data) collected from the business system 106 often contains not only table data such as CSV (Comma Separated Values) frequently used in an analysis tool or the like but also data in various formats such as BIN (binary), TXT (text), IMG (image), and PDF (Portable Document Format).

For this reason, to carry out data utilization such as analysis on the business data (raw data) from the business system 106 by utilization of various tools or development and utilization of applications, it is impossible to utilize the raw data as it is and necessary to carry out data preparation in many cases.

Therefore, as the data preparation, an analysis tool 321 utilized for data utilization in the data utilization system sequentially carries out a series of processing including tabulation 301, data coupling/extraction 302, data structuring 303, and data processing (cleansing) 304 on the raw data. In addition, the resultant data is set to have a data structure and a data format available in an analysis application 322 and a business application 323.

In other words, as the processing as the tabulation 301, individual data contents of the raw data are referred to, and the data in an original binary format is converted into an individual table 311 of data in a table format such as CSV such that the data can be easily handled.

As the processing as the data coupling/extraction 302, to extract data to be utilized in the tool, the applications, and the like for utilization, several individual tables 311 obtained by converting the raw data are coupled and a coupled table 312 containing the data to be utilized is created.

As the processing as the data structuring 303, the coupled table 312 is converted into structured data 313 that can be used by the analysis tool 321, the analysis application 322, and the business application 323 to be utilized for the data utilization.

In the present embodiment, the coupled table 312 is converted into the structured data 313 in a relation model table format normally used in various analysis tools and applications according to the purpose, a pivot table format used in cross tabulation and the like, a common data model format for each application, or the like.

As the processing as the data processing 304, data values are processed in such a manner that the structured data 313 is converted into individual application input data structures 314 for the analysis application 322, the analysis application 322, and the business application 323 utilized for the data utilization.

As the data processing 304, data cleansing processing, for example, such as unit conversion, error correction, and computer-assisted name identification is performed.

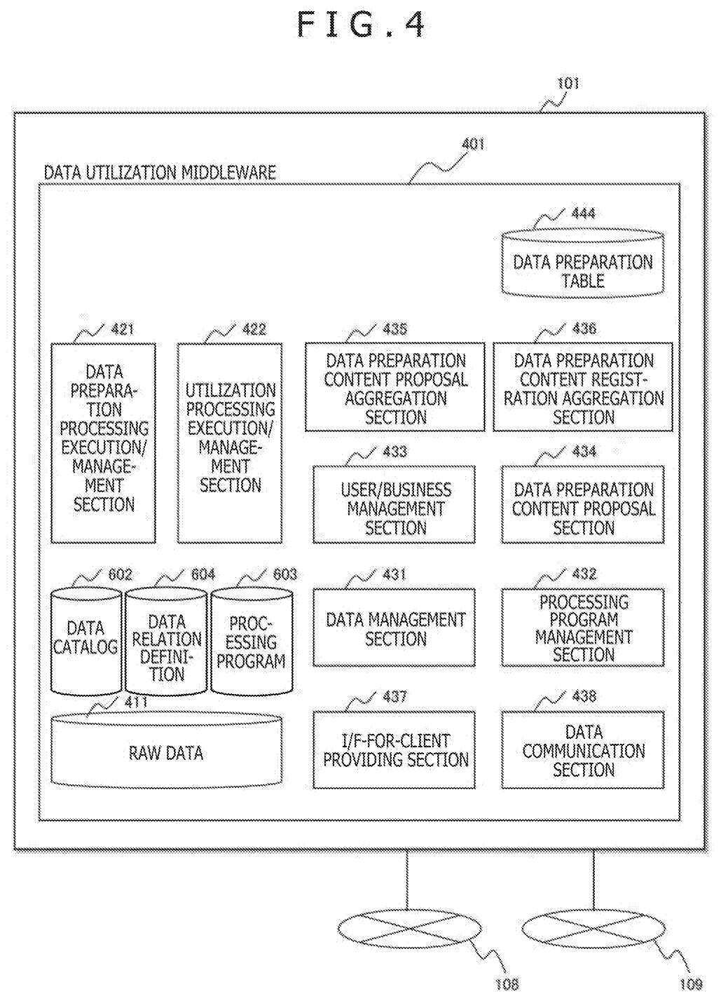

The data preparation processed as described above is stored in a data preparation table (refer to FIG. 4).

FIG. 4 is a diagram depicting a module configuration of the data utilization infrastructure server 101 according to the present invention.

The data utilization infrastructure server 101 is configured from data utilization middleware 401.

The data utilization middleware 401 has a function to accumulate the raw data provided from the business systems 106 to 108 and subjected to utilization in a raw data storage section 411 and to execute preparation processing on the data for the utilization, and a function to execute processing such as a proposal related to data preparation contents to the users and the system administrator managing data relation information related to the data preparation and the utilization, processing programs in a processing program storage section 603, and the like and utilizing data.

The data utilization middleware 401 includes a data preparation processing execution/management section 421, a utilization processing execution/management section 422, a data management section 431, a processing program management section 432, a user/business management section 433, a data preparation content proposal section 434, a data preparation content proposal aggregation section 435, a data preparation content registration aggregation section 436, an I/F-for-client providing section 437, a data communication section 438, and the like.

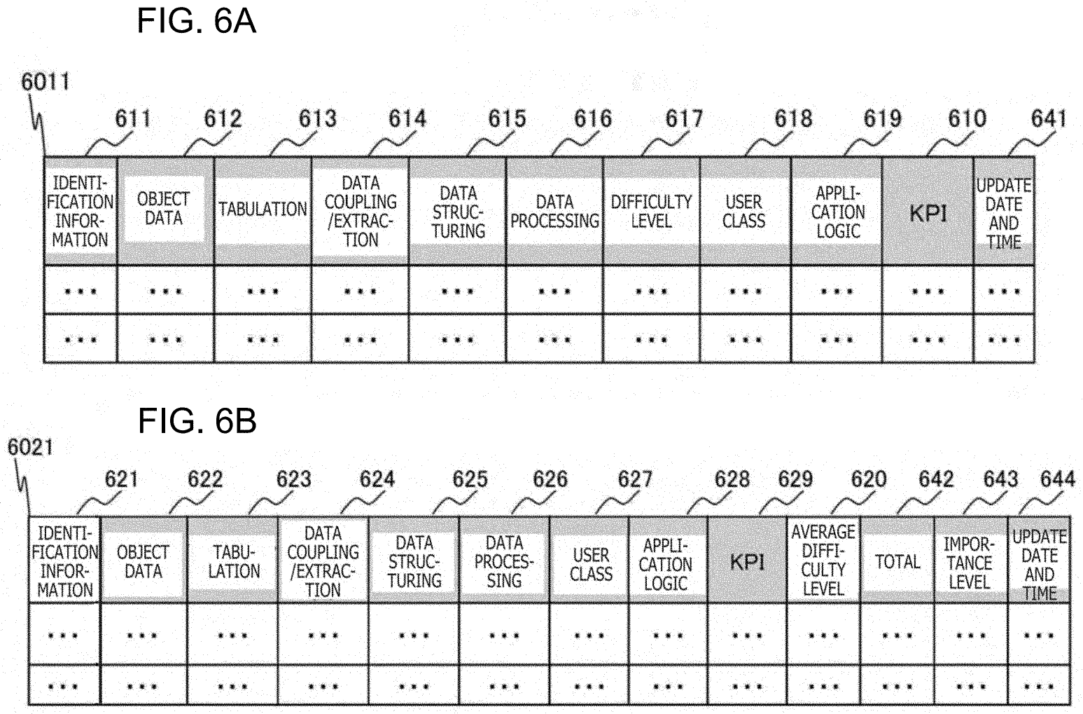

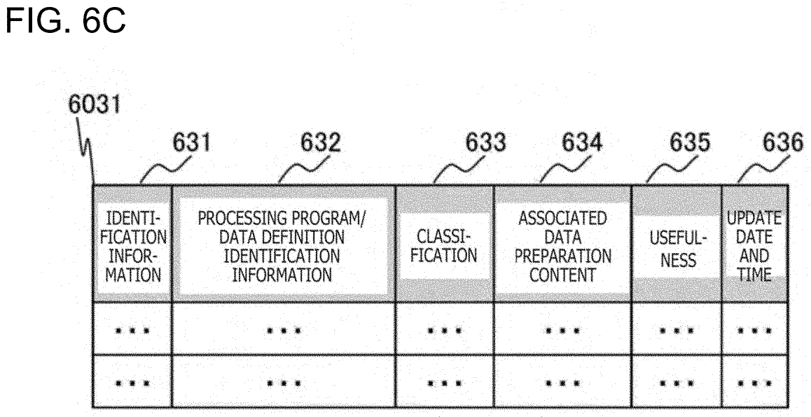

The data utilization middleware 401 also includes the raw data storage section 411 that stores therein the raw data from the business systems 106 to 108, a data catalog storage section 602 that stores therein a data catalog 502 (refer to FIG. 5(B)) prepared by the data utilization system, a processing program storage section 603 that stores therein a processing program list 503 (refer to FIG. 5(C)), a data relation definition storage section 604 that stores therein data relation information 504 (refer to FIG. 5(D)), a data preparation table storage section 444 that stores therein data related to the data preparation (refer to FIGS. 6(A) to 6(C)), and the like.

The raw data includes not only business system data from the business systems but also sensor data and open data.

The data preparation processing execution/management section 421 carries out execution and management of the data preparation processing on the data utilization infrastructure server 101 using the raw data accumulated in the raw data storage section 411 of the storage device 111, the processing program list registered in the processing program storage section 603, and the like.

In other words, the data preparation processing execution/management section 421 carries out the data preparation that enables data utilization for various purposes using diverse data from the plurality of business systems 106 to 108, and has functions:

to collate the requested data items and the input data structure of the utilization purpose of the user making utilization of data with the data information (for example, the data catalog, the data relation information, and the like of the raw data) prepared by the data utilization system;

to calculate data preparation contents (work items) to be carried out and difficulty levels thereof; and

to manage a data preparation content proposal management table (refer to 6011 in FIG. 6(A)).

The data preparation is to prepare data necessary to enable even a person insufficient in knowledge related to intended work and an intended system to promptly and easily make utilization of data, and to enable, for example, a user making utilization of data to use by various tools and applications (utilize data depending on various purposes and use applications such as carrying out of analysis and creation of the business application).

In addition, examples of the data preparation contents include the tabulation of the raw data, the data coupling/extraction for individual tables obtained by the tabulation, the data structuring for the structured data, and data processing (cleansing) for individual application input data structures.

Examples of the tabulation include binary-CSV conversion and CSV table format conversion, examples of the data coupling/extraction include relation data (track master and the like) and coupling keys (mileage, clock times, and the like), examples of the data structuring include creation of a relation model table and conversion into an integrated data model, and examples of the data processing include unit conversion and computer-assisted name identification.

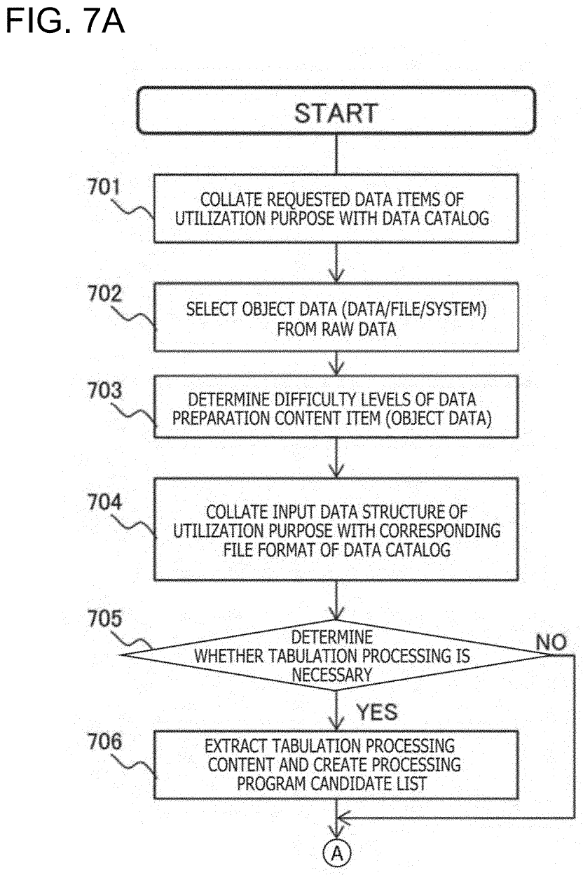

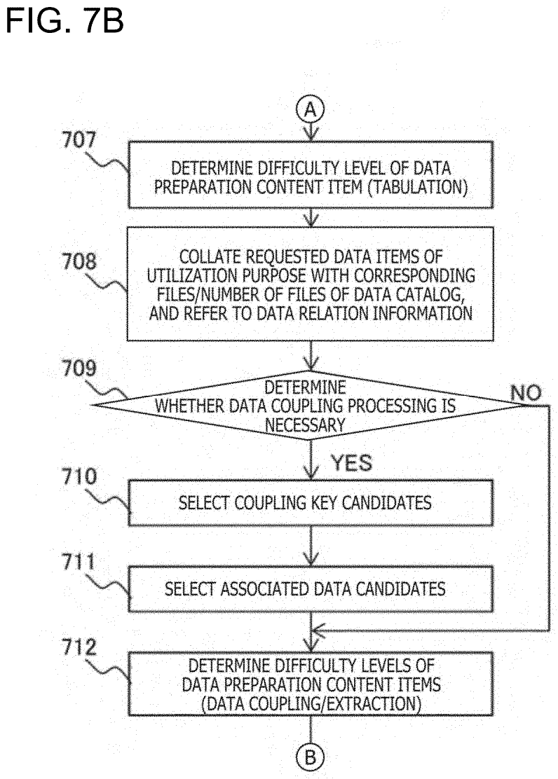

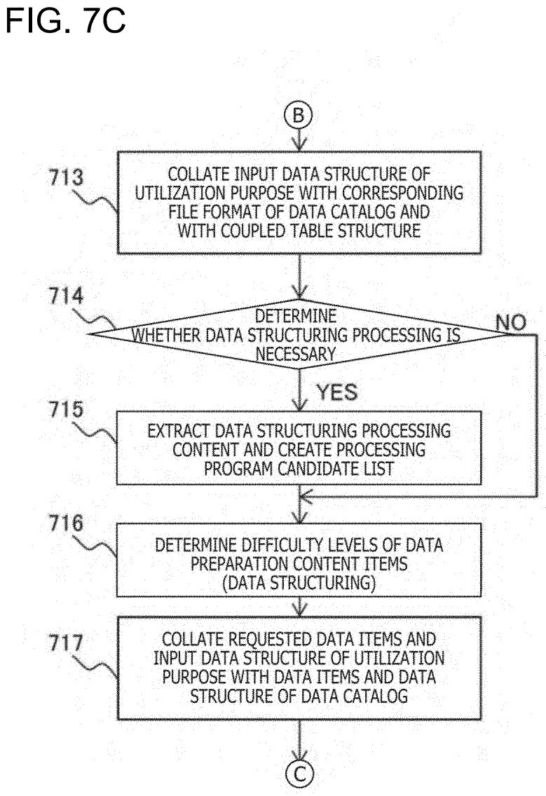

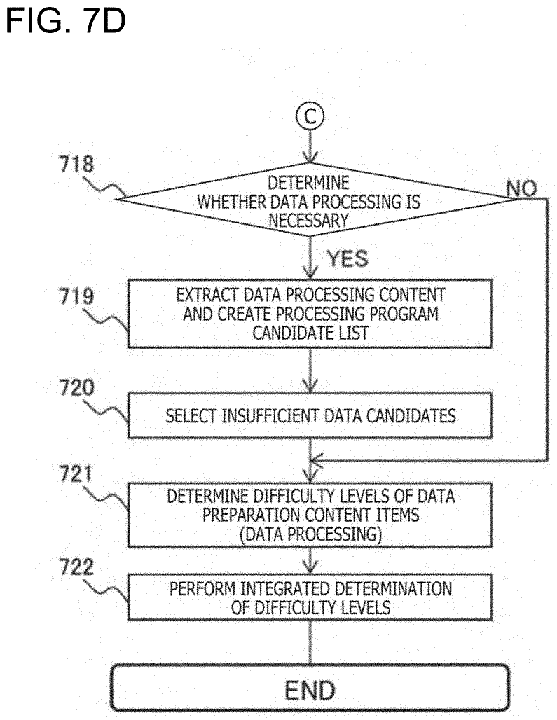

Procedures of the data preparation processing described above will be described later with reference to FIGS. 7(A) to 7(D).

The utilization processing execution/management section 422, which carries out execution and management of the utilization processing on the data utilization infrastructure server 101, aggregates data preparation proposal achievements and results of user's carrying out, and calculates importance levels of the data preparation contents. The utilization processing execution/management section 422 calculates the importance level per category of the data preparation contents.

In other words, the utilization processing execution/management section 422 has a function to determine similarities of the data preparation contents per item calculated by the data preparation processing execution/management section 421, to categorize similar data preparation contents, and to create a list of associated utilization purposes (candidates),

a function to calculate the importance levels, that is, degrees at which the data preparation contents are needed for utilization, on the basis of the average difficulty level per group of the data preparation contents and the total number of the data preparation contents, and

a function to manage the data preparation content category management table (refer to 6021 in FIG. 6(B)).

Examples of the utilization purposes (candidates) include a user class (analyst, developer, or the like) and application logic (calculation of causal connection, output of a line graph, or the like). The total number is a total number of the data preparation contents per group obtained by the data preparation content proposal aggregation section 435 and the data preparation content registration aggregation section 436.

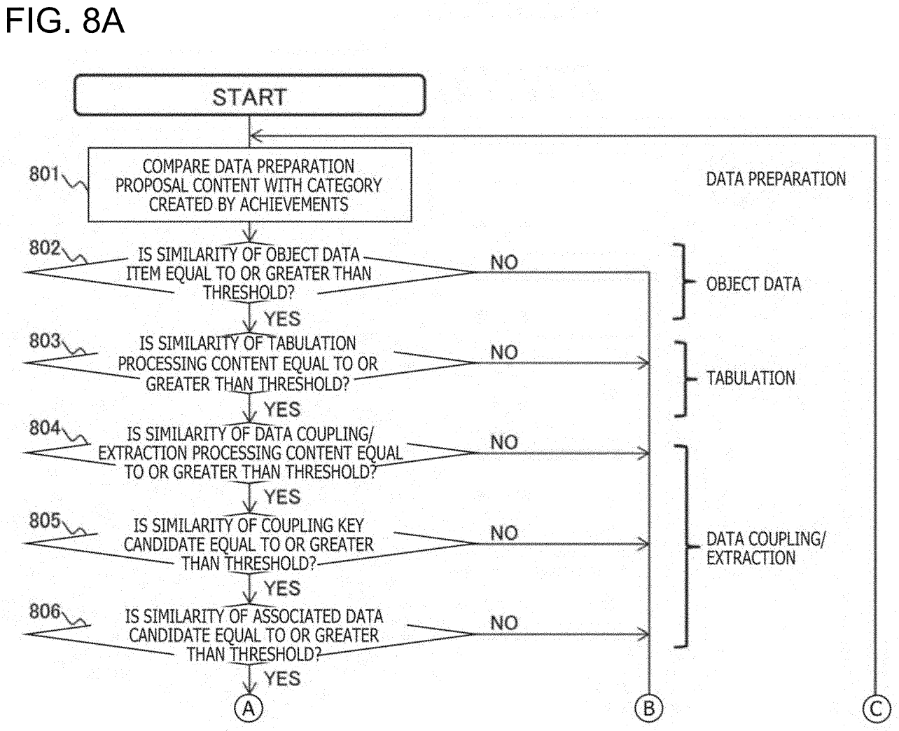

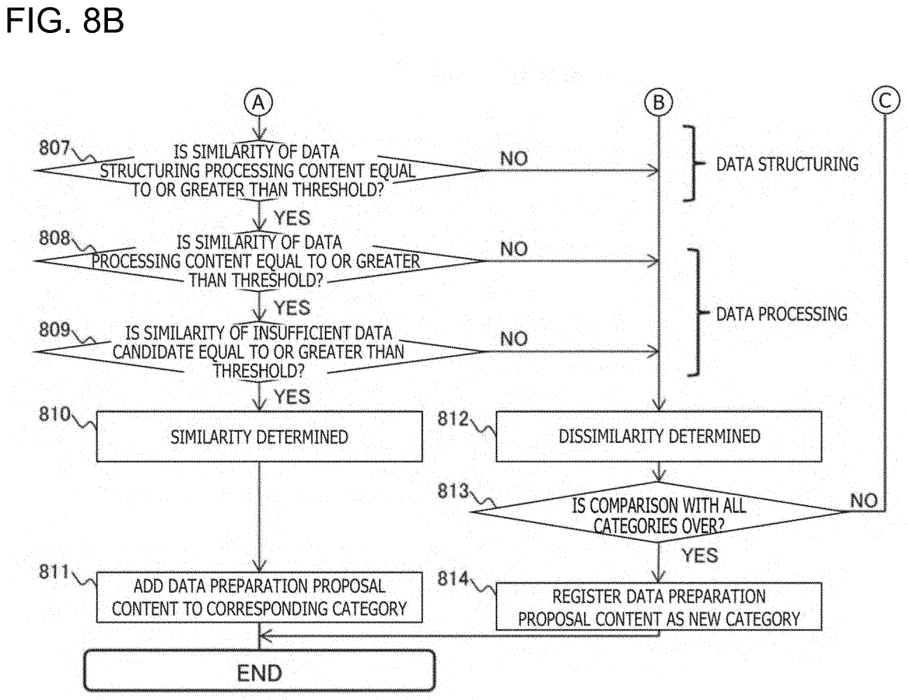

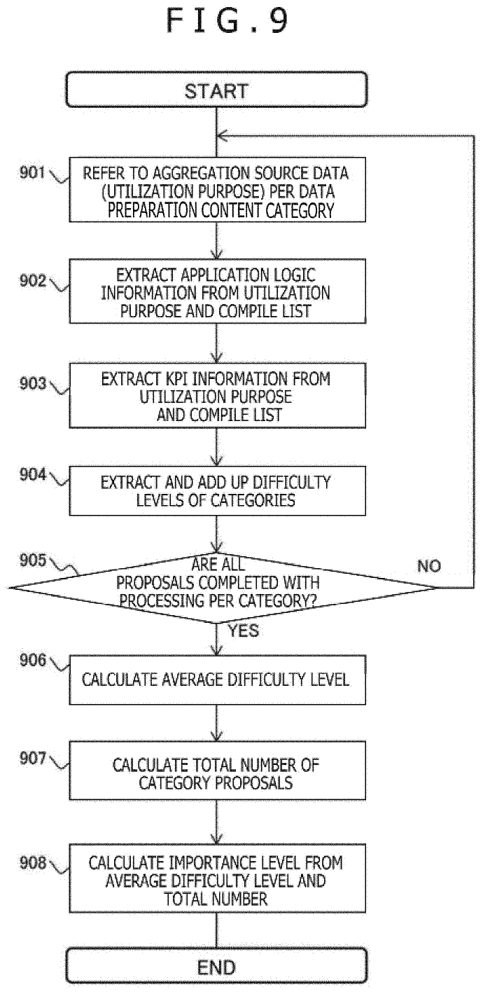

Procedures of the utilization processing for calculating the importance levels described above will be described later with reference to FIGS. 8(A), 8(B), and 9.

Furthermore, the utilization processing execution/management section 422 has a function to create a list of a result of user's registration of the data preparation content items, processing programs corresponding to the data preparation content items, data definitions, and the like, and to calculate usefulnesses of the data definitions.

In other words, the utilization processing execution/management section 422 has a function to search the data preparation contents corresponding to the processing programs and the data definitions by the user, to calculate the usefulnesses of the processing programs and the data definitions while referring to the importance levels of the data preparation content categories, to update the usefulnesses, and to manage a useful data preparation content item management table (refer to 6031 in FIG. 6(C)).

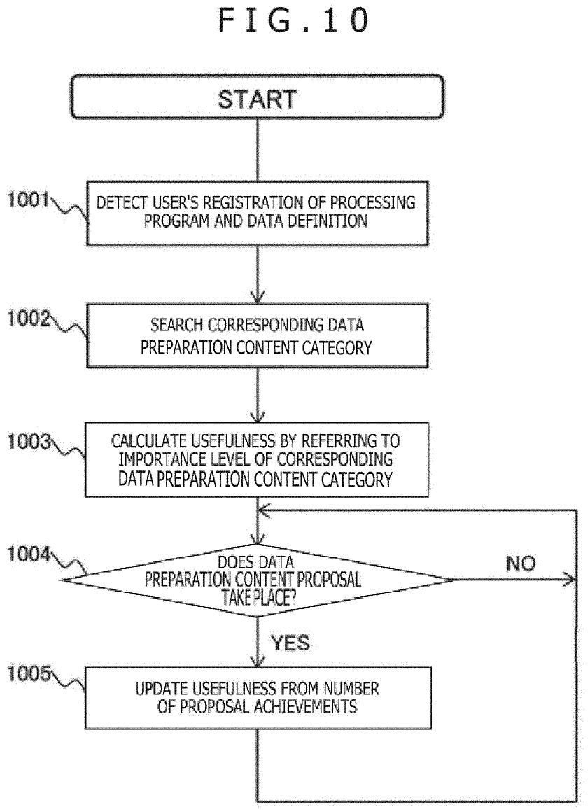

Procedures of the utilization processing for calculating the usefulnesses described above will be described later with reference to FIG. 10.

The data management section 431 carries out management of storing the raw data, the data catalog, and the data relation information in the raw data storage section 411, the data catalog storage section 602, and the data relation definition storage section 604.

The processing program management section 432 manages the processing program list in the processing program storage section 603 and accepts user's registration of the processing programs, the data relation definitions, and the like.

The user/business management section 433 manages the users (system administrator, analyst, and developer) accessing the present data utilization middleware 401 and making utilization of data and businesses.

The data preparation content proposal section 434 carries out processing for proposing the data preparation contents (data preparation content items) on the user's utilization purpose while referring to the data catalog, the data relation information, the processing program list, and the data preparation table.

In other words, the data preparation content proposal section 434 proposes, to the users, the data preparation contents, the importance levels, the usefulnesses, and the like obtained by the data preparation processing execution/management section 421 and the utilization processing execution/management section 422, and has a function to propose work items, methods, and the like for data preparation to, for example, the analyst and the developer making utilization of data, and to propose combinations of the importance levels of data preparation to be made for various purposes of various users and preparation contents with high necessity.

The data preparation content proposal aggregation section 435 refers to the data preparation table and carries out aggregation of data preparation content proposal achievements and categorization of the data preparation contents.

The data preparation content registration aggregation section 436 aggregates user's registered processing programs, data relation definitions, and the like with respect to the categories of the data preparation contents.

The I/F-for-client providing section 437 provides interfaces for the functions provided by the present data utilization middleware 401 to the data preparation content registration aggregation section 436, the administrator terminal 102, and the user terminals 103 to 105.

The data communication section 438 communicates data such as the data preparation content item proposal with the administrator terminal 102, the user terminals 103 to 105, and the business systems 106 to 108 via the networks 109 and 109′.

FIG. 5 are diagrams depicting configurations of a utilization purpose 501 created by a user, the data catalog 502, the processing program list 503, and the data relation information 504 prepared by the data utilization infrastructure server 101 in the data utilization system, in the data preparation method related to data utilization according to the present invention, FIG. 5(A) is a diagram depicting an example of the utilization purpose 501, FIG. 5(B) is a diagram depicting an example of the data catalog 502, FIG. 5(C) is a diagram depicting an example of the processing program list 503, and FIG. 5(D) is a diagram depicting an example of the data relation information 504.

The data catalog 502, the data relation information 504, and the processing program list 503 are stored in the data catalog storage section 602, the data relation definition storage section 604, and the processing program storage section 603 depicted in FIG. 4.

The utilization purpose 501 and the data catalog 502 are not optional herein to carry out the data preparation method related to data utilization according to the present invention.

On the other hand, the processing program list 503 and the data relation information 504 are assumed to be optional.

In other words, while the data preparation method related to data utilization according to the present invention can be carried out without the processing program list 503 and the data relation information 504, accuracy of the data preparation content proposal and the like in the data preparation method related to data utilization according to the present invention is more improved with the processing program list 503 and the data relation information 504.

Information associated with a purpose at the time of user's carrying out data utilization using data from the business system 106 is described in the utilization purpose 501, and the utilization purpose 501 is created per data utilization carried out by the user.

The utilization purpose 501 contains, for example, “requested data items,” “input data structure,” “application logic,” and “KPI.” The “requested data items” and the “input data structure” are not optional, while the “application logic” and the “KPI” are optional.

The “requested data items” indicate a class/item of data requested in the analysis tool 321, the analysis application 322, and the business application 323 utilized for the present utilization, and a data range (clock time or the like).

The “input data structure” indicates a structure of input data requested in the analysis tool 321, the analysis application 322, and the business application 323 utilized for the present utilization. For example, any one of a relation model table (CSV), a pivot table, and a common data model of every kind is designated.

The “application logic” is to designate a class, a business class, and the like of logic of analysis or the like used in the analysis application 322 and the business application 323 utilized for the present utilization.

The “KPI” is to designate a KPI to be achieved as a purpose of the present utilization.

The data catalog 502 is used to describe information associated with the raw data from the business system 106, and contains information (catalog information) such as a system that is a source, a data item list containing a file configuration, a time of creation, and a file format, per data.

The data catalog 502 is created and updated whenever data from the business system 106 is registered in the data utilization infrastructure server 101.

The processing program list 503 is a list of processing programs available for a series of processing (Steps 301 to 304 of FIG. 3) for data preparation, managed by the data utilization infrastructure server 101.

Programs concerned are described in the case of presence in the data utilization infrastructure server 101.

The data relation information 504 is used to describe a combination of specifications-related data item relations, a combination of business data item relations, a combination of business record relations, a combination of business know-how relations, and the like with respect to the data from the business system 106. Although a load for creating the data relation information 504 is heavy, the accuracy of the data preparation content proposal can be more improved with the information.

FIG. 6 are diagrams depicting data configurations of tables used to carry out the data preparation method related to data utilization and managed by the storage device 111 of the data utilization infrastructure server 101 according to the present invention, FIG. 6(A) is a table diagram depicting a data configuration of a data preparation content proposal management table 6011, FIG. 6(B) is a table diagram depicting a data configuration of a data preparation content category management table 6021, and FIG. 6(C) is a table diagram depicting a data configuration of a useful data preparation content item management table 6031.

The data preparation content proposal management table 601 stores information associated with a data preparation content proposal for the utilization purpose designated by a user. The data preparation content proposal management table 601 mainly contains items indicating information such as identification information 611, object data 612, tabulation 613, data coupling/extraction 614, data structuring 615, data processing 616, difficulty level 617, user class 618, application logic 619, KPI 610, and update date and time 641.

The identification information 611 is information for identifying a data preparation content proposal. The object data 612 is information associated with the object data 612 in the data preparation content proposal identified by the identification information 611.

The tabulation 613 is information associated with tabulation in the data preparation content proposal identified by the identification information 611.

The data coupling/extraction 614 is information associated with data coupling/extraction in the data preparation content proposal identified by the identification information 611.

The data structuring 615 is information associated with data structuring in the data preparation content proposal identified by the identification information 611.

The data processing 616 is information associated with data processing in the data preparation content proposal identified by the identification information 611.

The difficulty level 617 is information associated with a difficulty level in the data preparation content proposal identified by the identification information 611.

The user class 618 is information associated with a user class to be subjected to the data preparation content proposal identified by the identification information 611.

The application logic 619 is information associated with application logic contained in the user's utilization purpose to be subjected to the data preparation content proposal identified by the identification information 611, and the present item is blank in a case in which the utilization purpose does not contain the information associated with application logic.

The KPI 610 is information associated with KPI contained in the user's utilization purpose to be subjected to the data preparation content proposal identified by the identification information 611, and the present item is blank in a case in which the utilization purpose does not contain the information associated with the KPI. The update date and time 641 is a date and time at of last update of a record.

The data preparation content category management table 6021 stores information associated with a data preparation content category. The data preparation content category management table 6021 mainly contains items indicating information such as identification information 621, object data 622, tabulation 623, data coupling/extraction 624, data structuring 625, data processing 626, user class 627, application logic 628, KPI 629, average difficulty level 620, total 642, importance level 643, and update date and time 644.

The identification information 621 is information for identifying a data preparation content category.

The object data 622 is information associated with the object data in the data preparation content category identified by the identification information 621.

The tabulation 623 is information associated with tabulation in the data preparation content category identified by the identification information 621.

The data coupling/extraction 624 is information associated with data coupling/extraction in the data preparation content category identified by the identification information 621.

The data structuring 625 is information associated with data structuring in the data preparation content category identified by the identification information 621.

The data processing 626 is information associated with data processing in the data preparation content category identified by the identification information 621.

The user class 627 is information associated with a user class in the data preparation content category identified by the identification information 621.

The application logic 628 is information associated with application logic extracted from the utilization purpose associated with the data preparation content proposal that forms the basis of the data preparation content category identified by the identification information 621. A plurality of application logics associated with the data preparation content category can be present and a plurality of records can be stored.

The KPI 629 is information associated with a KPI extracted from the utilization purpose associated with the data preparation content proposal that forms the basis of the data preparation content category identified by the identification information 621. A plurality of KPIs associated with the data preparation content category can be present and a plurality of records can be stored.

The average difficulty level 620 is information associated with an average difficulty level in the data preparation content category identified by the identification information 621.

The total 642 is information associated with a total number in the data preparation content category identified by the identification information 621.

The importance level 643 is information associated with an importance level in the data preparation content category identified by the identification information 621.

The update date and time 644 is a date and time of last update of each record.

The useful data preparation content item management table 6031 stores information associated with useful data preparation content items for the data preparation content categories. The useful data preparation content item management table 6031 mainly contains items indicating information such as identification information 631, processing program/data definition identification information 632, classification 633, associated data preparation content 634, usefulness 635, and update date and time 636.

The identification information 631 is information identifying a data preparation content item. The processing program/data definition identification information 632 is information identifying a processing program or a data definition in the data preparation content item identified by the identification information 631. The classification 633 is information associated with a classification in the data preparation content item identified by the identification information 631.

In the present embodiment, any one of “tabulation,” “data coupling/extraction,” “data structuring,” and “data processing” is stored in the classification 633. The associated data preparation content 634 is information identifying a data preparation content proposal associated with the data preparation content item identified by the identification information 631. The usefulness 635 is information associated with a usefulness of the data preparation content item identified by the identification information 631. The update date and time 636 is a date and time of last update of each record.

FIGS. 7(A) to 7(D) are flowcharts depicting a flow of processing for collating the user's created utilization purpose 501 with data information (including the data catalog 502) prepared by the data utilization system and calculating data preparation work items to be carried out and difficulty levels, performed by the data utilization infrastructure server 101 (processing device 112) in the data utilization system in the case of applying the data preparation method related to data utilization according to the present invention.

Operations based on the flowcharts of FIGS. 7(A) to 7(D) are as follows.

### Step 701:

The data utilization infrastructure server 101 collates the requested data items in the utilization purpose 501 created by the user with the data items of the file in the data catalog 502 prepared by the data utilization infrastructure server 101. In the present embodiment, the requested data items include the class/item and the range (clock time, and the like) of the requested data, as depicted in FIG. 5(A).

### Step 702:

The data utilization infrastructure server 101 selects object data (designated by data/file/system) to serve as a target from the raw data in the business system in accordance with a result of collation of Step 701. In the present embodiment, the object data includes a rail abrasion rate, a tonnage, delay padding, a station arrival clock time, a station departure clock time, a temperature, and the like.

### Step 703:

The data utilization infrastructure server 101 determines difficulty levels of the data preparation content items with respect to selection of the object data in accordance with results of Steps 701 and 702. In other words, the data utilization infrastructure server 101 determines the difficulty levels of the data preparation content items (object data 612 of FIG. 6(A)) with respect to the class, the item, and the range of the user's requested data.

In the present embodiment, it is assumed that the difficulty level is high when the number of pieces of data extracted as data corresponding to the requested data items is large, and low when the number is small.

### Step 704:

The data utilization infrastructure server 101 collates the input data structure of the utilization purpose 501 with the file format of the corresponding data in the data catalog 502. In the present embodiment, the input data structure is the relation model table (CSV), the pivot table, the common data model of every kind, or the like, as depicted in FIG. 5(A).

### Step 705:

The data utilization infrastructure server 101 goes to next Step 706 in the case of determining that tabulation processing is necessary (YES) as a result of Step 704, and goes to Step 707 in the case of determining that tabulation processing is unnecessary.

### Step 706:

The data utilization infrastructure server 101 extracts a tabulation processing content for the data preparation content items. Furthermore, the data utilization infrastructure server 101 creates a processing program candidate list when the processing program corresponding to the tabulation processing content is registered in the data utilization infrastructure server 101. Examples of the processing program candidates include a binary conversion program and a model conversion program.

### Step 707:

The data utilization infrastructure server 101 determines difficulty levels of the data preparation content item (tabulation 613 of FIG. 6(A)) with respect to the tabulation in accordance with results of Steps 704 to 706.

In the present embodiment, it is assumed that the difficulty level is high when the tabulation processing is necessary, and low when the tabulation processing is unnecessary. In addition, it is assumed that the difficulty level is high when the processing program candidate corresponding to the tabulation processing is not registered in the data utilization infrastructure server 101, and low when the processing program candidate is registered therein.

### Step 708:

The data utilization infrastructure server 101 collates the requested data items of the utilization purpose 501 with files of the corresponding data and the number of files of the data catalog 502, and also refers to the data relation information 504 if present.

### Step 709:

The data utilization infrastructure server 101 goes to Step 710 in the case of determining that data coupling processing is necessary (YES) as a result of Step 708, and goes to Step 712 in the case of determining that data coupling processing is unnecessary (NO).

### Step 710:

The data utilization infrastructure server 101 selects coupling key candidates (axis designation/mileage, clock time, and the like in data coupling/extraction) used in data coupling of the data relation information 504 in accordance with a result of Step 708. For example, data common to a plurality of tables to be coupled can be a coupling key.

### Step 711:

The data utilization infrastructure server 101 selects associated data candidates (master designation/line master and the like in data coupling/extraction) on the basis of the data relation information 504 in accordance with a result of Step 708. For example, master data of various codes and the like correspond to the associated data candidates.

### Step 712:

The processing device 112 of the data utilization infrastructure server 101 determines difficulty levels of the data preparation content items (data coupling/extraction 614 of FIG. 6(A)) with respect to the data coupling/extraction in accordance with results of Steps 708 to 711.

In the present embodiment, it is assumed that the difficulty level is high when the data coupling/extraction processing is necessary, and low when the data coupling/extraction processing is unnecessary. In addition, it is assumed that the difficulty level is high when the number of selected coupling key candidates is small, and low when the number is large. Furthermore, it is assumed that the difficulty level is high when the number of the selected associated key candidates is small, and low when the number is large.

### Step 713:

The data utilization infrastructure server 101 collates the input data structure of the utilization purpose 501 with the file format of the corresponding data in the data catalog 502 and a coupled table structure derived as a result of Steps 708 to 711.

### Step 714:

The data utilization infrastructure server 101 goes to Step 715 in the case of determining that data structuring processing is necessary (YES) as a result of Step 713, and goes to Step 716 in the case of determining that the data structuring processing is unnecessary (NO).

### Step 715:

The data utilization infrastructure server 101 extracts a data structuring processing content. In addition, the data utilization infrastructure server 101 creates a processing program candidate list when the processing program corresponding to the data structuring processing content is registered in the data utilization infrastructure server 101.

### Step 716:

The data utilization infrastructure server 101 determines difficulty levels of the data preparation content items (data structuring 615 of FIG. 6(A)) with respect to the data structuring in accordance with results of Steps 713 to 715.

In the present embodiment, it is assumed that the difficulty level is high when the data structuring processing is necessary, and low when the data structuring processing is unnecessary. In addition, it is assumed that the difficulty level is high when the processing program candidate corresponding to the data structuring processing is not registered in the data utilization infrastructure server 101, and low when the processing program candidate is registered therein.

### Step 717:

The data utilization infrastructure server 101 collates the requested data items and the input data structure of the utilization purpose 501 with the data items in the data catalog 502 and a data structure derived as a result of Steps 713 to 715.

### Step 718:

The data utilization infrastructure server 101 goes to Step 719 in the case of determining that data processing is necessary (YES) as a result of Step 717, and goes to Step 721 in the case of determining that data processing is unnecessary (NO).

### Step 719:

The data utilization infrastructure server 101 extracts a data processing content. In addition, the data utilization infrastructure server 101 creates a processing program candidate list when the processing program corresponding to the data processing content is registered in the data utilization infrastructure server 101.

### Step 720:

The data utilization infrastructure server 101 selects insufficient data candidates in accordance with a result of Step 717.

The insufficient data candidate is data which is contained in the requested data items of the utilization purpose 501 but for which corresponding data is not present in the data catalog 502.

### Step 721:

The data utilization infrastructure server 101 determines difficulty levels of the data preparation content items (data processing 616) with respect to the data processing in accordance with results of Steps 717 to 720.

In the present embodiment, it is assumed that the difficulty level is high when the data processing is necessary, and low when the data processing is unnecessary. In addition, it is assumed that the difficulty level is high when the processing program candidate corresponding to the data processing is not registered in the data utilization infrastructure server 101, and low when the processing program candidate is registered therein. Furthermore, it is assumed that the difficulty level is high when the number of the selected insufficient data candidates is large, and low when the number is small.

### Step 722:

The data utilization infrastructure server 101 performs integrated determination of difficulty levels of the data preparation content items (object data, tabulation, data coupling/extraction, data structuring, and data processing) in accordance with determination results of Steps 703, 707, 712, 716, and 721.

FIGS. 8(A) and 8(B) are flowcharts depicting a flow of processing for determining similarities of the data preparation contents per item from the data preparation proposal achievements and categorizing similar data preparation contents, performed by the data utilization infrastructure server 101 in the data utilization system in the case of applying the data preparation method related to data utilization according to the present invention.

Operations based on the flowcharts of FIGS. 8(A) and 8(B) are as follows.

### Step 801:

The data utilization infrastructure server 101 compares the data preparation proposal content with data preparation content proposal achievements (grouped category).

### Step 802:

The data utilization infrastructure server 101 determines whether or not the similarity of the object data item is equal to or greater than a threshold as a result of Step 801.

Here, the processing goes to Step 803 in a case in which the similarity of the object data item is equal to or greater than the threshold (YES), and the processing goes to Step 812 in a case in which the similarity of the object data item is smaller than the threshold (NO) and it is determined in Step 812 that the object data item is not similar to the category.

### Step 803:

The data utilization infrastructure server 101 determines whether or not the similarity of the tabulation processing content is equal to or greater than a threshold.

Here, the processing goes to Step 804 in a case in which the similarity of the tabulation processing content is equal to or greater than the threshold (YES), and goes to Step 812 in a case in which the similarity of the tabulation processing content is smaller than the threshold (NO).

### Step 804:

The data utilization infrastructure server 101 determines whether or not the similarity of the data coupling/extraction processing content is equal to or greater than a threshold.

Here, the processing goes to Step 805 in a case in which the similarity of the data coupling/extraction processing content is equal to or greater than the threshold (YES), and goes to Step 812 in a case in which the similarity of the data coupling/extraction processing content is smaller than the threshold (NO).

### Step 805:

The data utilization infrastructure server 101 determines whether or not the similarity of the coupling key candidate is equal to or greater than a threshold.

Here, the processing goes to Step 806 in a case in which the similarity of the coupling key candidate is equal to or greater than the threshold (YES), and goes to Step 812 in a case in which the similarity of the coupling key candidate is smaller than the threshold (NO).

### Step 806:

The data utilization infrastructure server 101 determines whether or not the similarity of the associated data candidate is equal to or greater than a threshold.

Here, the processing goes to Step 807 in a case in which the similarity of the associated data candidate is equal to or greater than the threshold (YES), and goes to Step 812 in a case in which the similarity of the associated data candidate is smaller than the threshold (NO).

### Step 807:

The data utilization infrastructure server 101 determines whether or not the similarity of the data structuring processing content is equal to or greater than a threshold.

Here, the processing goes to Step 808 in a case in which the similarity of the data structuring processing content is equal to or greater than the threshold (YES), and goes to Step 812 in a case in which the similarity of the data structuring processing content is smaller than the threshold (NO).

### Step 808:

The data utilization infrastructure server 101 determines whether or not the similarity of the data processing content is equal to or greater than a threshold.

Here, the processing goes to Step 809 in a case in which the similarity of the data structuring processing content is equal to or greater than the threshold (YES), and goes to Step 812 in a case in which the similarity of the data structuring processing content is smaller than the threshold (NO).

### Step 809:

The data utilization infrastructure server 101 determines whether or not the similarity of the insufficient data candidate is equal to or greater than a threshold.

Here, the processing proceeds to Step 810 in a case in which the similarity of the insufficient data candidate is equal to or greater than the threshold (YES), and goes to Step 812 in a case in which the similarity of the insufficient data candidate is smaller than the threshold (NO).

### Step 810:

The data utilization infrastructure server 101 determines that the data preparation proposal content is similar to the category and the processing goes to Step 810 in a case in which the similarity is determined to be equal to or greater than the threshold in each of Steps 802 to 809.

### Step 811:

The data utilization infrastructure server 101 adds the data preparation proposal content to the category. In other words, the data utilization infrastructure server 101 adds the utilization purpose of the data preparation proposal content to the associated utilization purposes (user class, application logic, and KPI) per category, and updates the average difficulty level, the total number, and the importance level of the category.

The difficulty level of the category includes the difficulty level of the object data, the difficulty level of the tabulation, the difficulty level of the data coupling/extraction, the difficulty level of the data structuring, and the difficulty level of the data processing, and these difficulty levels are calculated while being weighted. It is assumed that the importance level is high in the case of the difficulty level: high and the total: large, and low in the case of the difficulty level: low and the total: small.

### Step 812:

The data utilization infrastructure server 101 determines that the data preparation proposal content is not similar to the category and the processing goes to Step 813 in a case in which it is determined that the similarly is smaller than the threshold in each of Steps 802 to 809.

### Step 813:

The data utilization infrastructure server 101 determines whether or not comparison with all categories is over, and repeats the processing from Steps 801 to 812 in the case of determining that the comparison with all categories is not over (NO). The data utilization infrastructure server 101 proceeds to Step 814 and registers the data preparation proposal content as a new category in a case in which comparison with all categories is over (YES).

It is noted that each of the thresholds described above is a predetermined threshold set in advance.

FIG. 9 is a flowchart depicting a flow of processing for calculating the importance level of the data preparation content with respect to a category.

Operations based on the flowchart of FIG. 9 are as follows.

### Step 901:

The data utilization infrastructure server 101 refers to the utilization purpose 501 for each of the data preparation content proposals that form the basis of aggregation per data preparation content category.

### Step 902:

The data utilization infrastructure server 101 extracts application logic information and compiles a list containing the application logic information when the utilization purpose 501 contains the application logic information.

### Step 903:

The data utilization infrastructure server 101 extracts KPI information and compiles a list containing the KPI information when the utilization purpose 501 contains the KPI information.

### Step 904:

The data utilization infrastructure server 101 extracts and adds up the difficulty levels of the data preparation content proposals that form the basis of aggregation per data preparation content category.

### Step 905:

The data utilization infrastructure server 101 determines whether or not all the data preparation content proposals that form the basis of aggregation are completed with the processing in Steps 901 to 904 per data preparation content category, and the processing returns to Step 901 and repeats the processing in Steps 901 to 904 when all the data preparation content proposals are not completed with the processing.

The processing goes to Step 906 when all the data preparation content proposals are completed with the processing in Steps 901 to 904 per data preparation content category.

### Step 906:

The data utilization infrastructure server 101 calculates the average difficulty level from a result of adding up of the difficulty levels in Step 904.

### Step 907:

The data utilization infrastructure server 101 calculates a total number of proposals that form the basis of aggregation per data preparation content category.

### Step 908:

The data utilization infrastructure server 101 calculates the importance level from the average difficulty level and the total number calculated in Steps 906 and 907.

Here, the importance level is calculated by, for example, the following equation.

(Importance level)=w₁×(average difficulty level)+w₂×(total), where w₁ and w₂ are weights.

From the equation, the importance level becomes higher as the average difficulty level is higher and the total is larger. In addition, the importance level becomes lower as the average difficulty level is lower and the total is smaller.

FIG. 10 is a flowchart depicting a flow of processing for creating a list containing the processing programs corresponding to the data preparation content items, the data definitions, and the like as a result of registration of the data preparation content items by the user.

Operations based on the flowchart of FIG. 10 are as follows.

### Step 1001:

The data utilization infrastructure server 101 detects registration of a processing program and a data definition by user's creation to the data utilization infrastructure server 101.

### Step 1002:

The data utilization infrastructure server 101 searches a data preparation content category corresponding to the processing program and the data definition registered in Step 1001.

### Step 1003:

The data utilization infrastructure server 101 calculates the usefulness of the processing program and the data definition by referring to the importance level of the corresponding data preparation content category.

Here, the usefulness is calculated by, for example, the following Equation.

(Usefulness)=w₁×(importance level)+w₂×(number of proposal achievements), where w₁ and w₂ are weights

### Step 1004:

The data utilization infrastructure server 101 waits until a new data preparation content proposal takes place.

The processing goes to Step 1005 in a case in which a new data preparation content proposal takes place (YES) in Step 1004, and the data utilization infrastructure server 101 continues to wait until a new data preparation content proposal takes place in a case in which any new data preparation content proposal does not take place (NO).

### Step 1005:

The data utilization infrastructure server 101 updates the usefulness from the number of proposal achievements. The processing then returns to Step 1004.

FIGS. 11(A) to 11(C) are diagrams depicting conceptual screenshots of screens for indicating information contents provided to users using the user terminals 103 to 105 to which the present invention is applied.

A screen 1101 indicates object data 1111 and a table format 1112 in data preparation contents proposed for, for example, the utilization purpose 501 registered by the user.

In the table format 1112, a list of, for example, the classifications (tabulation, data coupling/extraction, data structuring, and data processing), the work items (whether or not each work item is necessary, and proposed work contents), the processing programs (binary conversion processing program 1 and model conversion program 2), and the difficulty levels (numeric values) is displayed in the data preparation contents proposed for the user's utilization purpose 501. It is noted that the list containing blank parts is displayed in the case of absence of corresponding information.

On a screen 1102, a list of, for example, the data preparation contents (object data, tabulation, data coupling/extraction, data structuring, and data processing), the associated utilization purposes (user class, application logic, and KPI), the average difficulty levels (numerical values), totals (numerical values), and the importance levels (numerical values) is displayed in a table format 1121 as the data preparation content category as a result of aggregation of achievements of data preparation content proposals. It is noted that the list containing blank parts is displayed in the case of absence of corresponding information.

On a screen 1103, a list of, for example, the classifications, the processing programs, the data definitions, the associated data preparation contents, and the usefulnesses is displayed in a table format 1131 as a useful data preparation content item list. It is noted that the list containing blank parts is displayed in the case of absence of corresponding information.

According to the embodiment described so far, it is possible to achieve promotion of data utilization across departments and businesses and reduction of a development cost related to data utilization and analysis services. Furthermore, in a case in which the analysis is required utilizing data across the departments and businesses for solution of various problems in a transportation field, it is possible for even a person insufficient in understanding of diverse business data, that is, for even a person insufficient in knowledge related to object business systems, to promptly and easily utilize data, and to reduce burden related to the data preparation (data extraction, table/list construction, processing, and the like) for making utilization of data for various purposes and use applications.

### DESCRIPTION OF REFERENCE CHARACTERS

101: Data utilization infrastructure server
102: Administrator terminal
103 to 105: User terminal
106 to 108: Business system
109, 109′: Network
111, 121, 131: Storage device
112, 122, 132: Processing device
113, 123, 133: Communication device
401: Data utilization middleware
421: Data preparation processing execution/management section
422: Utilization processing execution/management section
431: Data management section
432: Processing program management section
433: User/business management section
434: Data preparation content proposal section
435: Data preparation content proposal aggregation section
436: Data preparation content registration aggregation section

1. A data preparation method related to data utilization in a data utilization system that accumulates and manages data collected from a plurality of business systems and provides functions related to data preparation and data utilization for utilization of the data, the data preparation method comprising:
a first step of collating a utilization purpose designated by a user with data information prepared by the data utilization system, selecting data preparation content items of object data to be carried out for the utilization purpose from the data, calculating a difficulty level of each of the data preparation content items, and presenting the calculated difficulty level to the user;
a second step of aggregating data preparation content items for the utilization purpose, categorizing similar data preparation contents, calculating an importance level of the categorized data preparation contents, and presenting the calculated importance level to the user and an administrator of the data utilization system; and
a third step of creating a list containing processing programs and data relation definitions corresponding to the data preparation content items for a category of the similar data preparation contents, calculating a usefulness of each of the data preparation content items, and presenting the calculated usefulness to the user.

2. The data preparation method related to data utilization according to claim 1, wherein
as data preparation for carrying out the utilization purpose using raw data from the plurality of business systems, a series of processing including tabulation, data coupling/extraction, data structuring, and data processing are sequentially carried out on the raw data from the business systems.

3. The data preparation method related to data utilization according to claim 1, wherein
the utilization purpose designated by the user contains a requested data item, an input data structure, an application logic, and a KPI,
the data information prepared by the data utilization system contains a data catalog, data relation information, and a processing program list associated with the data collected from the business systems, and
the first step includes
a collation step of collating the utilization purpose with the data information containing the data catalog, and
at a time of calculating the data preparation content items,
an object data selection step of selecting object data from the data collected from the business systems,
a tabulation processing necessary/unnecessary determination step of determining whether or not tabulation processing on the object data extracted in the object data selection step is necessary,
a tabulation processing content extraction step of extracting a tabulation processing content of the object data in a case of determining that the tabulation processing is necessary in the tabulation processing necessary/unnecessary determination step,
a data coupling processing determination step of determining whether or not data coupling/extraction processing is necessary,
a step of selecting a coupling key candidate coupled to the tabulation processing content in a case of determining that the data coupling processing is necessary in the data coupling processing determination step,
an associated data candidate selection step of selecting an associated data candidate on a basis of the data relation information,
a data structuring processing necessary/unnecessary determination step of determining whether or not data structuring processing is necessary,
a data structuring processing content extraction step of extracting a content of the data structuring processing,
a data processing necessary/unnecessary determination step of determining whether or not data processing is necessary,
a data processing content extraction step of extracting a content of the data processing in a case of determining that the data processing is necessary in the data structuring processing necessary/unnecessary determination step, and
an insufficient data candidate selection step of selecting an insufficient data candidate.

4. The data preparation method related to data utilization according to claim 1, further comprising:
a step of calculating the difficulty level as an easiness to carry out each item of the calculated preparation content items at a time of calculating the data preparation content items by collating the utilization purpose designated by the user with the data information prepared by the data utilization system; and
a step of integrating the difficulty level of each of the data preparation content items and calculating a difficulty level of the data preparation contents.

5. The data preparation method related to data utilization according to claim 1, wherein
the first step includes
comparing each item proposal content of the data preparation contents for the utilization purpose with a category already created from data preparation content proposal achievements, and sequentially determining whether or not a similarity of an object data item is equal to or greater than a threshold, whether or not a similarity of a tabulation processing content is equal to or greater than a threshold, whether or not a similarity of a data coupling/extraction processing content is equal to or greater than a threshold, whether or not a similarity of a coupling key candidate is equal to or greater than a threshold, whether or not a similarity of an associated data candidate is equal to or greater than a threshold, whether or not a similarity of a data structuring processing content is equal to or greater than a threshold, whether or not a similarity of a data processing content is equal to or greater than a threshold, and whether or not a similarity of an insufficient data candidate is equal to or greater than a threshold, and
determining whether the data preparation contents belong to the existing data preparation category or a new category is set for the data preparation contents.

6. The data preparation method related to data utilization according to claim 1, further comprising:
extracting difficulty levels of data preparation content proposals that form a basis of aggregation per item of a data preparation content category for calculating an importance level of the data preparation content category;
adding up the difficulty levels and calculating an average difficulty level;
calculating a total number of proposals that form the basis of aggregation per item of the data preparation content category; and
calculating the importance level of the data preparation content category from the average difficulty level and the total number.

7. The data preparation method related to data utilization according to claim 1, further comprising:
creating a list of useful data preparation content items for data preparation content categories of the data preparation contents, and selecting a data preparation content category corresponding to the data preparation content items such as the processing programs and the data definitions registered by the user in the step of calculating and presenting the usefulness of each item; and
calculating the usefulness of each of the data preparation content items from an importance level of the data preparation content category and the number of proposal achievements.

8. The data preparation method related to data utilization according to claim 1, further comprising:
a step of outputting information associated with the object data, work items, and the like, information associated with the data preparation content category obtained as a result of aggregation of data preparation content proposals, and information associated with the data preparation content item list to present to the user as a data preparation content in response to user's registration of the utilization purpose.

9. A data preparation method in a data utilization system that accumulates and manages data collected from a plurality of business systems and provides data preparation that enables utilization of the data and data preparation content items of the data preparation to a user, the data preparation method comprising:
a step of executing data preparation processing; and
a step of executing utilization processing, wherein
the step of executing the data preparation processing includes
collating a utilization purpose designated by the user with data information prepared by the data utilization system, obtaining data preparation content items of object data to be carried out for the utilization purpose from the data, and calculating a difficulty level of each of the data preparation content items, and
the step of executing the utilization processing includes
aggregating the data preparation content items for the data preparation, categorizing similar data preparation contents, and calculating an importance level of a data preparation content category obtained by categorization, and
enabling the data preparation contents and the importance level to be proposed to the user.

10. The data preparation method in the data utilization system according to claim 9, wherein
the utilization purpose contains a requested data item and an input data structure,
the data information contains a data catalog, and the data catalog contains a data item, a clock time, and a file format,
the data preparation content items include tabulation, data coupling/extraction, data structuring, and data processing, and
the importance level is calculated on a basis of an average difficulty level and a total number of the data preparation contents.

11. The data preparation method in the data utilization system according to claim 9, wherein
the step of executing the data preparation processing further includes
compiling a list of associated utilization purposes for every category of the data preparation contents, and calculating a usefulness of each of the data preparation content items, and
the step of proposing the data preparation contents further includes
presenting the usefulness to the user.

12. The data preparation method in the data utilization system according to claim 11, wherein
to compile the list of the associated utilization purposes means to create a list containing processing programs and data relation information corresponding to the data preparation contents as associated data candidates.

13. A data utilization system that accumulates and manages data collected from a plurality of business systems and presents data preparation enabling utilization of the data and data preparation content items of the data preparation to a user, the data utilization system comprising:
a data preparation processing execution section that executes processing on the data preparation;
a utilization processing execution section that executes utilization processing on the data preparation; and
a data preparation content proposal section that proposes a content of the data preparation, wherein
the data preparation processing execution section includes
a processing section that collates a utilization purpose designated by the user with data information prepared by the data utilization system, and
a processing section that obtains data preparation content items of object data to be carried out for the utilization purpose from the data, and calculates a difficulty level of each of the data preparation content items,
the utilization processing execution section includes
a processing section that aggregates data preparation content items for the data preparation,
a processing section that categorizes the similar data preparation contents, and
a processing section that calculates an importance level of the categorized data preparation contents having the data preparation content items, and
the data preparation content proposal section includes
a processing section that proposes the data preparation contents and the importance level to the user.

14. The data utilization system according to claim 13, wherein
the utilization purpose contains a requested data item and an input data structure,
the data information contains a data catalog, and the data catalog contains a data item, a clock time, and a file format,
the data preparation content items include tabulation, data coupling/extraction, data structuring, and data processing, and
the importance level is calculated on a basis of an average difficulty level and a total number of the data preparation contents.

15. The data utilization system according to claim 13, wherein
the data preparation processing execution section further includes
a processing section that compiles a list of associated utilization purposes for every category of the data preparation contents, and a processing section that calculates a usefulness of each of the data preparation content items, and
the data preparation content proposal section further includes
a processing section that presents the usefulness to the user.
